(19) United States
(12) Patent Application Publication
(10) Pub. No.: US 2025/0384785 A1
(43) Pub. Date: Dec. 18, 2025

(54) METHODS AND DEVICES FOR TRAINING FINGER POSITION

(71) Applicant: Armaan Mehta, Malvern, PA (US)

(72) Inventor: Armaan Mehta, Malvern, PA (US)

(21) Appl. No.: 19/240,871

(22) Filed: Jun. 17, 2025

Related U.S. Application Data
(60) Provisional application No. 63/661,451, filed on Jun. 18, 2024.
(60) Provisional application No. 63/675,986, filed on Jul. 26, 2024.
(60) Provisional application No. 63/780,684, filed on Mar. 31, 2025.

(51) Int. Cl. G09B 15/06; B33Y 50/00; B33Y 80/00

(52) U.S. Cl. CPC G09B 15/06; B33Y 80/00; B33Y 50/00

(57) ABSTRACT

Provided herein are wearable devices which serve as joint training units, method of using the joint training units, and methods of making joint training units. The present disclosure provides joint training units to assist in training a person to adopt the correct hand or finger positioning during an activity. For example, these wearable training units can be used to encourage proper hand and finger positioning while a person is playing piano. Such training units train a subject to maintain proper hand or finger positioning in a manner which is superior to the existing training methods or devices, which provide reduced flexibility and convenience relative to those of the present disclosure.

### CROSS-REFERENCE

This application claims priority to U.S. Provisional Patent Application No. 63/661,451, filed on Jun. 18, 2024; U.S. Provisional Application No. 63/675,986, filed on Jul. 26, 2024, all of which are incorporated herein by reference; and U.S. Provisional Patent Application No. 63/780,684, filed on Mar. 31, 2025.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BACKGROUND

Certain tasks, such as playing piano or typing on a computer, are associated with improper and proper joint positioning. There exists a need for a comfortable, non-invasive means for such training. Piano players, for example, need to train their fingers to maintain a slightly bent position. The typical method for doing so uses a ball-and-strap design, which is bulky and restricts the user's ability to play. Alternative training methods involve piano finger trainers, which cannot be used while playing piano.

### SUMMARY

The present disclosure provides wearable devices for maintaining or encouraging a desired joint position, and systems and methods for using and making those wearable devices (also referred to herein as “wearable training units”). A summary of various exemplary embodiments is presented. Some simplifications and omissions may be made in the following summary, which is intended to highlight and introduce aspects of certain embodiments disclosed herein, but not to limit the scope of the disclosure. Detailed descriptions of various embodiments adequate to allow those of ordinary skill in the art to make and use the concepts disclosed herein will follow in later sections.

In some embodiments, provided herein is a wearable device comprising a single unit of housing comprising a flexible material with shape resilience, the single unit comprising a first hollow portion connected to a second hollow portion at a bend, wherein the wearable device is configured to wrap around a joint in the finger of a subject to encourage a bent position of the joint, and wherein the first hollow portion and the second hollow portion are continuously connected, such that the first hollow portion and the second hollow portion do not separate at the bend.

In some embodiments, the wearable device is configured to encourage the bent position of the joint when worn while the subject is engaging in an activity. In some embodiments, the activity comprises playing an instrument. In some embodiments, the instrument is a piano, an organ, an accordion, a harpsichord, an electronic keyboard, a melodica, a spinet, a keyboard glockenspiel, a piano, a celesta, a dulcitone, or a synthesizer. In some embodiments, the activity is typing on a keyboard. In some embodiments of the wearable devices provided herein, the housing comprises a cylindrical, tubular, or otherwise hollow shape which is maintained in an elbowed structure.

In some embodiments, the joint comprises the distal interphalangeal joint. In some embodiments, the joint comprises the proximal interphalangeal joint.

In some embodiments, the single unit comprises a first hollow portion connected to a second hollow portion at a bend, and the bend is at an angle greater than about 90°. In some embodiments, the angle is greater than about 120°. In some embodiments, the angle is from about 100° to about 170°. In some embodiments, the angle is from about 110° to about 160°. In some embodiments, the angle is from about 120° to about 150°. In some embodiments, the angle is from about 130° to about 140°. In some embodiments, the angle is 135° or about 135°.

In some embodiments, the flexible material with shape resilience comprises a polymer. In some embodiments, the flexible material comprises silicone, thermoplastic polyurethane, thermoplastic copolyester, thermoplastic elastomer, or polypropylene. In some embodiments, the flexible material comprises thermoplastic polyurethane.

Also provided herein are methods of manufacturing the wearable devices provided herein. In some embodiments, the method comprises: A) determining (i) a circumference of a finger on the subject and (ii) a desired resting position of the joint in the finger; B) preparing, based at least in part on (i) and (ii), a model of wearable device; C) providing the model to a 3D printer configured to produce the wearable device, thereby manufacturing the wearable device.

Also provided herein are methods of using the wearable devices provided herein. In some embodiments, the method of using the wearable device comprises wearing the wearable device during an activity associated with a proper hand positioning to encourage the proper hand positioning during the activity associated with the proper hand positioning, wherein the activity is playing an instrument.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

### BRIEF DESCRIPTION OF THE DRAWINGS

A better understanding of the features and advantages of the present invention will be obtained by reference to the following detailed description that sets forth illustrative embodiments, in which the principles of the invention are utilized, and the accompanying drawings (also “Figure” and “FIG.” herein), of which:

FIG. 1 provides four perspectives of a non-limiting example of a wearable training unit shaped for the subject to wear on a finger to encourage a slightly bent position of the finger.

FIG. 2 show a subject using a wearable training unit while playing piano.

FIGS. 3A-3D provide exemplary diagrams of wearable training units described herein, with exemplary measurements indicated.

FIG. 4 provides an example of a wearable training unit without flexible properties.

FIGS. 5A-5C provide a glove coupled with bent, rigid units which fit inside the glove to encourage specific finger positions.

FIGS. 6A-6B provide examples of traditional finger position training device for use in playing piano.

FIG. 7A-7B demonstrate an activity associated with a proper hand positioning, during which the wearable training units can be worn to encourage the proper hand positioning.

FIG. 8 provides an example of measurement specifications for a wearable training unit, which can be used to create a 3D-printed wearable training unit.

### DETAILED DESCRIPTION OF THE INVENTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

As used in this document, the singular forms “a, ” “an, ” and “the” include plural references unless the context clearly dictates otherwise. Unless defined otherwise, all technical and scientific terms used herein have the same meanings as commonly understood by one of ordinary skill in the art. As used in this document, the term “comprising” means “including, but not limited to, ”

As used herein, the term “about” when used in the context of the degree of an angle, is meant to refer to the specified angle ±5 degrees. For example. about 90 degrees can include anywhere from 85° to 95° (e.g., 85°, 86.7°, 89.5°, 90°, 90.5°, 91°, 91.25°, 93°, 95°, etc.).

The present disclosure provides wearable devices for maintaining or encouraging a desired joint positioning (referred to herein as “wearable training units”). Further provided are methods and systems of using and manufacturing the wearable training units provided herein. While the present disclosure focuses on using wearable training units designed to aid in playing an instrument (e.g., piano), the wearable training units can benefit a subject engaging in any field, task, or hobby that requires flexibility in a subject's fingers, while also requiring the subject's fingers to maintain or consistently return to a curled or bent position. For example, in some embodiments, the desired joint positioning is associated with learning to type on a computer keyboard.

Unless otherwise defined, all technical and scientific terms used herein have the same meaning as commonly understood by one of ordinary skill in the art to which this disclosure belongs. Although methods and materials similar or equivalent to those described herein can be used in the practice or testing of the present disclosure, suitable methods and materials are described below.

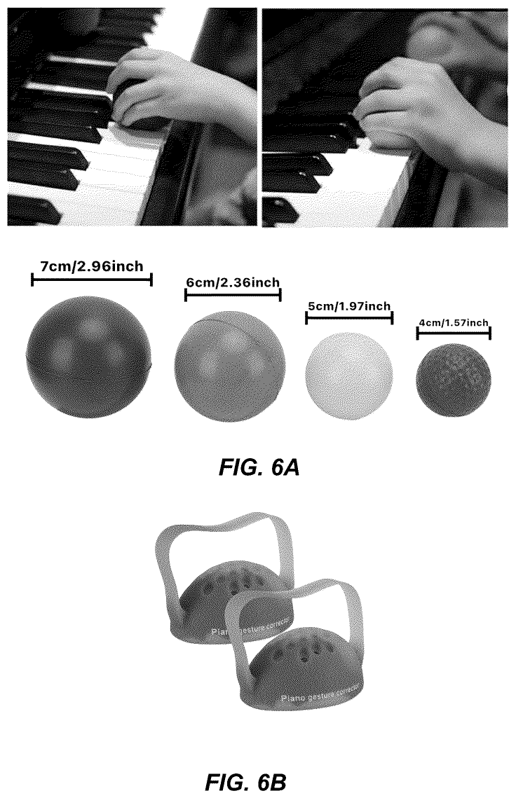

The present disclosure provides wearable devices for maintaining or encouraging a desired joint position, and systems and methods for using and making those wearable devices (also referred to herein as “wearable training units”). The wearable training units provided herein, particularly when used for playing piano (or similar instruments, including but not limited to an organ, an accordion, a harpsichord, an electronic keyboard, a melodica, a spinet, a keyboard glockenspiel, a piano, a celesta, a dulcitone, a synthesizer), show a distinct advantage over current devices used for teaching hand or finger positioning in the art. For example, the ball-design or the ball-and-strap design, exemplified in FIG. 6A and FIG. 6B, respectively, used in the art is bulky and does allow a user to play the full range of the piano while using, therefore impeding its ability to properly encourage muscle memory while playing the instrument. In contrast, the wearable training units provided herein are slim and, by allowing for flexibility without restricting movement, can encourage muscle memory for a person learning to play piano.

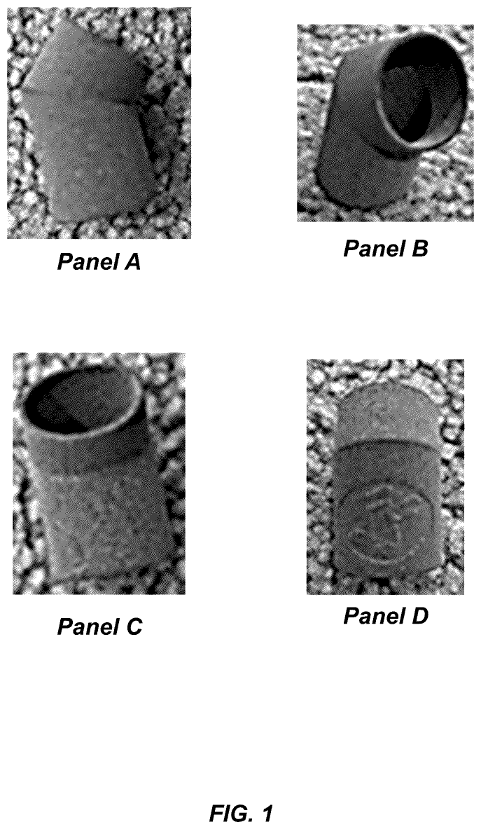

In some embodiments, the wearable training units comprise single-material, single-digit units. FIG. 1 provide four perspectives of an exemplary wearable training unit comprising a single-material, single-digit unit, which each Panel (Panel A, Panel B, Panel C, and Panel D) providing an alternative perspective of a wearable training unit. As shown, the wearable training units comprise a continuous cylindrical structure made from a flexible material, wherein the continuous cylindrical structure comprises a first cylindrical portion and a second cylindrical portion separated by a bend, and wherein the bend is configured to encourage a bent position of a jointed appendage (e.g., a finger) during an activity, without restricting the range of motion for that jointed appendage. The activity can be, for example, typing on a computer. The activity can be, for example, playing an instrument, such as a piano or electronic keyboard. The angle of the bend depends on the activity for which the training unit is being used (for example, between about 120° and 170° for playing piano or a similar keyboard instrument, preferably between 130° and 150°, e.g., 135° or about) 135°. For example, the angle of the bend can be 120°, 121°, 122°, 123°, 124°, 125°, 126°, 127°, 128°, 129°, 130°, 131°, 132°, 133°, 134°, 135°, 136°, 137°, 138°, 139°, 140°, 141°, 142°, 143°, 144°, 145°, 146°, 147°, 148°, 149°, 150°, 151°, 152°, 153°, 154°, 155°, 156°, 157°, 158°, 159°, 160°, 161°, 162°, 163°, 164°, 165°, 166°, 167°, 168°, 169°, 170° or more, depending on the desired resting position of the finger.

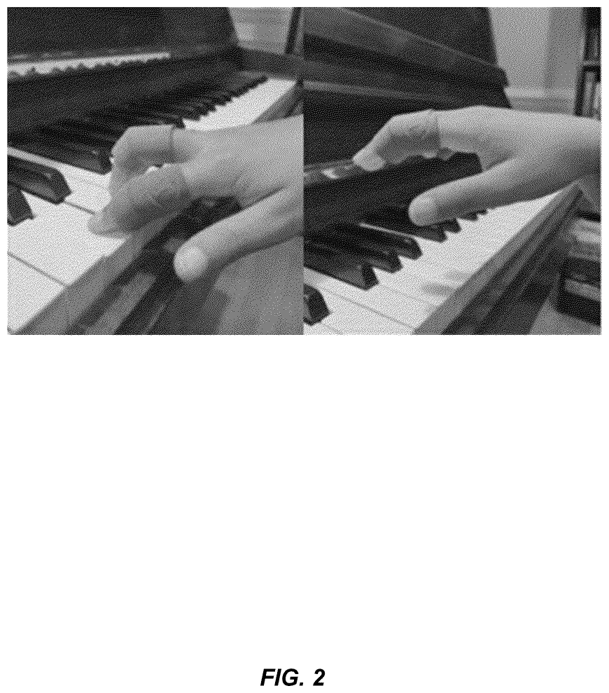

As discussed above, the wearable devices of the present invention can be applied to various embodiments, with the size of the wearable training unit and bend variable depending on the desired jointed appendage and position for that jointed appendage. For example, in an embodiment sufficient for playing piano, the wearable training is worn around the finger at the proximal interphalangeal joints to encourage the proper positioning of the fingers and hand during piano playing. Such an embodiment is shown in FIG. 2, which provides an example of a person using the wearable training unit to assist in learning the correct hand posture for playing piano. Here, the bend of the wearable training unit encourages the proper position for the distal (and proximal) joints, while the flexible material of the wearable training unit allows for the flexibility needed to quickly reach the wide range of octaves available on the instrument. In such an embodiment, the angle of the bend is about 135°. and the wearable training unit is worn on the index and middle fingers. However, the device can also be adapted for other instruments, such as for playing a flute or clarinet, or for other activities, such as to assist in proper finger positioning while typing on a computer, which might require an alternative angle of the bend.

As discussed above, FIG. 2 provides an example of a person using the wearable training unit to assist in learning the correct hand posture for playing piano. The wearable training units can be sized differently to best fit the user, and the angle of the bend can be adjusted for the activity or use desired (e.g., typing, playing piano, playing a wind instrument). For larger fingers. wearable training units will have larger diameters. For smaller fingers, wearable training units will have smaller diameters. A material with sufficient elasticity to comfortable fit around fingers of varying diameters while maintaining its structure to maintain positioning of a finger may also be suitable for the wearable training unit.

The wearable training units can comprise a wearable device consisting of a single unit comprising two connected portions, wherein the two connected portions comprise hollow cylindrical tubes connected at an angle sufficient to encourage a slight bend in position of a jointed appendage when inserted into the hollow unit. The connected portions are connected along the circumference of each hollow unit and do not separate, which makes the structure of the wearable training unit stronger and more resilient and allows for simplified manufacturing through processes such as 3D printing.

These wearable training units may comprise any skin-safe material that is flexible yet resilient (i.e., having structural integrity). The wearable training units may comprise any flexible yet resilient, biocompatible material with shape memory known to a person skilled in the art. In preferred embodiments, the material having structural integrity comprises a material that is skin-safe and child-safe (e.g., insignificant risk of choking through, e.g., a porous material). In the examples provided herein, TPU is used for the wearable training units. Thermoplastic Polyurethane (TPU) is a resilient, yet flexible material which encourages a bent (curled) figure position without restricting movement. While TPU is beneficial due to its low cost and biocompatibility, the wearables can comprise alternative materials, so long as the material has good structural integrity or resilience without sacrificing significant flexibility. For example, the wearable training unit may be made of silicone, thermoplastic copolyester (TPC), thermoplastic elastomer (TPE), and polypropylene (PP), or any similar rubber-like or polymeric material. The exemplary wearable training unit provided in FIG. 2 is made of TPU.

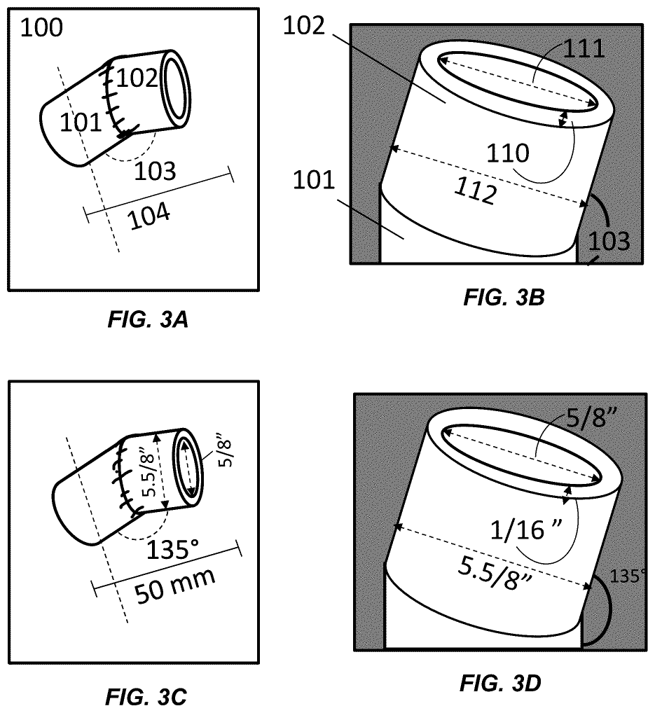

FIG. 3A and FIG. 3B provide diagrams of the structure for the wearable training units provided herein, with FIG. 3B providing an alternative view of the wearable training unit of FIG. 3A, zoomed in to a frame highlighting these dimensions. FIG. 3C and FIG. 3D provide diagrams with specific exemplary measurements for the wearable training units in FIG. 3A and FIG. 3B, respectively, for an embodiment of the wearable training unit sufficient for wearing by a subject to encourage the proper hand positioning for playing piano, with FIG. 3C corresponding to the perspective of the device in FIG. 3A, and FIG. 3D corresponding to the perspective of the device in FIG. 3B. The wearable training unit as shown is designed to fit comfortably of the middle-knuckle of a user on any finger. FIG. 3C and FIG. 3D provide only a nonlimiting example of size and shape specifications for a wearable training unit designed for maintaining positioning of a finger (e.g., index finger) while playing piano.

As shown in FIGS. 3A-3D, the wearable training units comprise a wearable device consisting of a single unit comprising two connected portions, wherein the two connected portions comprise hollow cylindrical tubes connected at an angle sufficient to encourage a slight bend in position of a jointed or flexible appendage when inserted into the hollow unit. In particular, FIG. 3A provides a wearable training unit 100, comprising a first cylindrical portion 101 connected to a second cylindrical portion 102 at an angle sufficient to create a bend 103, and FIG. 3B provides an alternative view of the wearable training unit. The bend 103 may be adjusted to any angle sufficient to encourage the desired joint position for a wearer of the device. The length of the device, before it is cut, is indicated by 104 in FIG. 3A. FIG. 3B provides an alternative view of the wearable training unit, zoomed in to a frame showing the some of the first cylindrical portion 101 and the full second cylindrical portion 102, with lines indicating the inner diameter 111, an outer diameter 112, and thickness 110 of the wearable training unit. In FIG. 3C and FIG. 3D, which represent specific measurements for playing piano, the wearable device has a bend 103 of 135°. The outer diameter 112 of the wearable training unit is 5.⅝ inches (or 11/16 inch), the inner diameter 111 is ⅝ inch. and the thickness 110 is 1/16 inch. The length of the device before it is cut (104) is 50 mm.

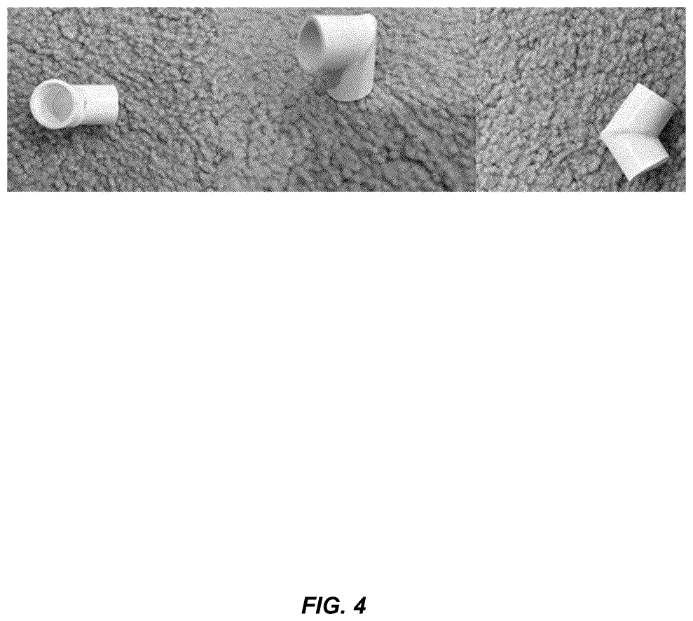

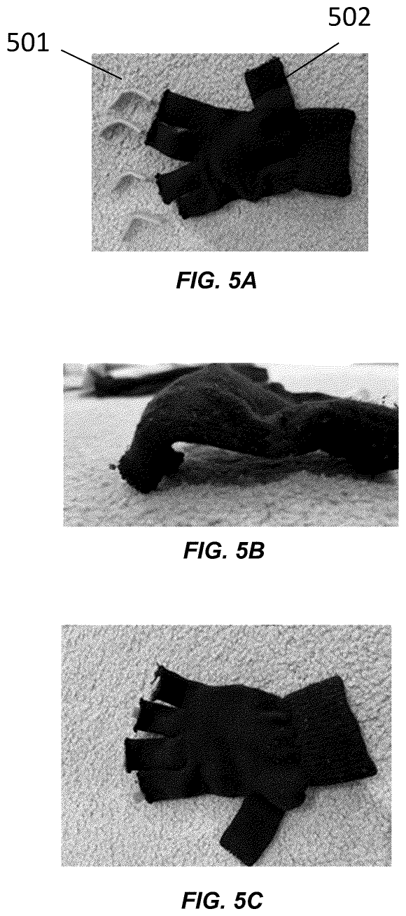

In an embodiment for playing piano, the flexible material of the wearable training units provided herein allows for encouraging the bent position while maintaining the flexibility or range of motion required for the subject to play the full range of the instrument. In contrast, the wearable unit provided in FIG. 4 would be ineffective because it is made of a hard, rigid material (PVC) which does not allow the flexibility required to move each finger from a bent (curled) position to a stretched position (as is required to play certain keys on the piano or to type on a keyboard, for example). The wearable training glove in FIGS. 5A-5C provides another example, which is inferior to the training units provided herein. FIG. 5A provides the components of the gloves. which include a cloth, fingerless glove (502) with wire bends (501), which would be sewn or otherwise attached at the tip of the glove to create the wearable training glove seen in FIG. 5B (side view) and FIG. 5C (top view). Although the glove in FIGS. 5A-5C allows for lateral flexibility to play different ranges, the rigid units (wire bends, 501) that encourage bending of the fingers do not allow for flexibility in extending the fingers and unbending the joints. However, the gloves in FIGS. 5A-5C can be adapted with the wearable training units in place of wire bends (501) responsible for rigidity, which would be sufficient for playing piano and similar embodiments. FIG. 6A provides an example of a training ball for playing piano, which is bulky and inconvenient compared to the wearable training units described herein. FIG. 6B provides an example of a ball-and-strap design, which is similarly bulky and inconvenient. The wearable training units, as adapted for playing piano and shown in, for example. FIG. 2, FIG. 3C, and FIG. 3D show significant improvements over these traditional tools used for training hand positioning while playing piano (or any similar keyboard instrument).

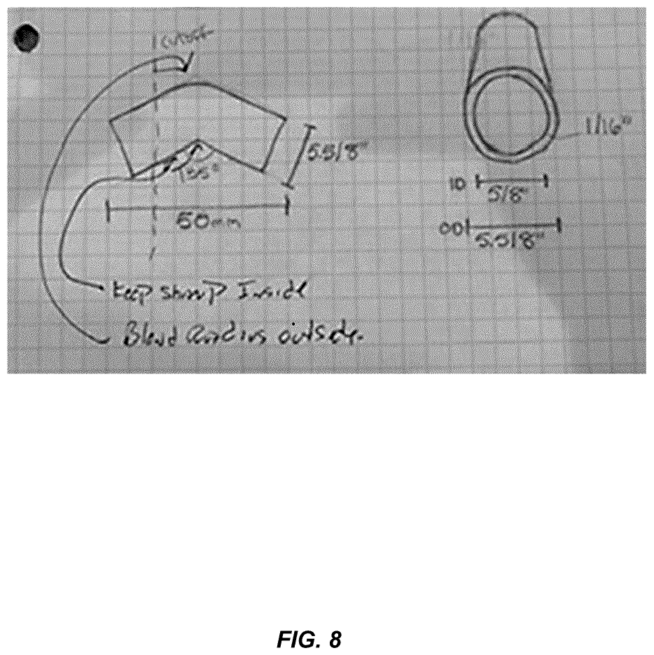

The wearable training units provided herein can be prepared via 3D printing. For example, methods of manufacturing wearable training units can comprise A) determining (i) a first circumference of a jointed appendage and (ii) a desired resting position of said jointed appendage; B) preparing, based at least in part on (i) and (ii), a model of the joint training device; and C) providing the model to a 3D printer configured to produce the joint training device, thereby manufacturing the joint training device. The exemplary wearable training unit provided in FIG. 2 was made via 3D printing using TPU using the dimensions provided in FIG. 3C, FIG. 3D, and FIG. 8.

### NON-LIMITING EXEMPLARY EMBODIMENTS

Embodiment 1. A wearable device comprising a single unit of housing comprising a flexible material with shape resilience, the single unit comprising a first hollow portion connected to a second hollow portion at a bend, wherein the wearable device is configured to envelop a joint in the finger of a subject to encourage a bent position of the joint, and wherein the first hollow portion and the second hollow portion are continuously connected, such that the first hollow portion and the second hollow portion do not separate at the bend.
Embodiment 2. The wearable device of Embodiment 1, wherein the wearable device is configured to encourage the bent position of the joint when worn while the subject is engaging in an activity.
Embodiment 3. The wearable device of Embodiment 2, wherein the activity comprises playing an instrument.
Embodiment 4. The wearable device of Embodiment 3, wherein the instrument is a piano, an organ, an accordion, a harpsichord, an electronic keyboard, a melodica, a spinet, a keyboard glockenspiel, a piano, a celesta, a dulcitone, or a synthesizer.
Embodiment 5. The wearable device of Embodiment 2, wherein the activity is typing.
Embodiment 6. The wearable device of Embodiment 1, wherein the housing comprises a cylindrical, tubular, or otherwise hollow shape which is maintained in an elbowed structure.
Embodiment 7. The wearable device of Embodiment 1, wherein the joint comprises the distal interphalangeal joint.
Embodiment 8. The wearable device of Embodiment 1, wherein the joint comprises the proximal interphalangeal joint.
Embodiment 9. The wearable device of Embodiment 1, wherein the bend is at an angle greater than about 90°.
Embodiment 10. The wearable device of Embodiment 9, wherein the angle is greater than 120°.
Embodiment 11. The wearable device of Embodiment 9, wherein the angle is from about 100° to about 170°.
Embodiment 12. The wearable device of Embodiment 11, wherein the angle is from about 110° to about 160°.
Embodiment 13. The wearable device of Embodiment 12, wherein the angle is from about 120° to about 150°.
Embodiment 14. The wearable device of Embodiment 13, wherein the angle is from about 130° to about 140°.
Embodiment 15. The wearable device of Embodiment 14, wherein the angle is 135° or about 135°.
Embodiment 16. The wearable device of Embodiment 1, wherein the flexible material comprises a polymer.
Embodiment 17. The wearable device of Embodiment 1, wherein the flexible material comprises silicone, thermoplastic polyurethane, thermoplastic copolyester, thermoplastic elastomer, or polypropylene.
Embodiment 18. The wearable device of Embodiment 17, wherein the flexible material comprises thermoplastic polyurethane.
Embodiment 19. A method of manufacturing the wearable device of any one of Embodiments 1-18, the method comprising: A) determining (i) a circumference of a finger on the subject and (ii) a desired resting position of the joint in the finger; B) preparing, based at least in part on (i) and (ii), a model of wearable device; C) providing the model to a 3D printer configured to produce the wearable device, thereby manufacturing the wearable device.
Embodiment 20. A method of using the wearable device of any one of Embodiments 1-18, comprising wearing the wearable device during an activity associated with a proper hand positioning to encourage the proper hand positioning during the activity associated with the proper hand positioning.
Embodiment 21. The method of Embodiment 20, wherein the activity associated with the proper hand positioning is playing an instrument.
Embodiment 22. The method of Embodiment 21, wherein the instrument is a piano, an organ, an accordion, a harpsichord, an electronic keyboard, a melodica, a spinet, a keyboard glockenspiel, a piano, a celesta, a dulcitone, a synthesizer, or a similar instrument.
Embodiment 23. The method of Embodiment 20, wherein the activity associated with the proper hand positioning is typing on a computer or keyboard.

The following non-limiting examples serve to further illustrate the present invention.

### EXAMPLES

### Example 1: Wearable for Teaching Curled Finger Position for Playing Piano

FIG. 1 shows a wearable training unit designed for use in playing piano. FIG. 2 shows a subject wearing the wearable training unit to encourage the fingers to return to a bent (curled) position at rest. To use the wearable training unit, the subject slides the wearable training unit over their finger until it rests on their knuckle at the distal interphalangeal joint, such as shown in FIG. 2. The subject can adjust the wearable training unit until comfortable, and then play the piano as they normally would. While playing, the slight bend and flexible material encourages a bent finger position for the user, while allowing the user to fully extend their fingers while playing, such that they can play and reach higher octaves than a traditional ball or ball-and-strap method for teaching piano. FIG. 3C and FIG. 3D provide the specifications for a wearable training unit, including a bend at 135°, which is helpful for training a subject to maintain the proper resting position of the fingers while playing piano. Such embodiments provide exemplary specifications which can be adjusted slightly (for example, the angle of the bend can be from 130° to 140° or the inner or outer circumference of the wearable training unit can be increased or decreased to better fit larger or smaller fingers/joints), and such adjustments are not expected to significantly impact the useability or functionality of the device.

### Example 2: Wearable for Teaching Curled Finger Position for Typing

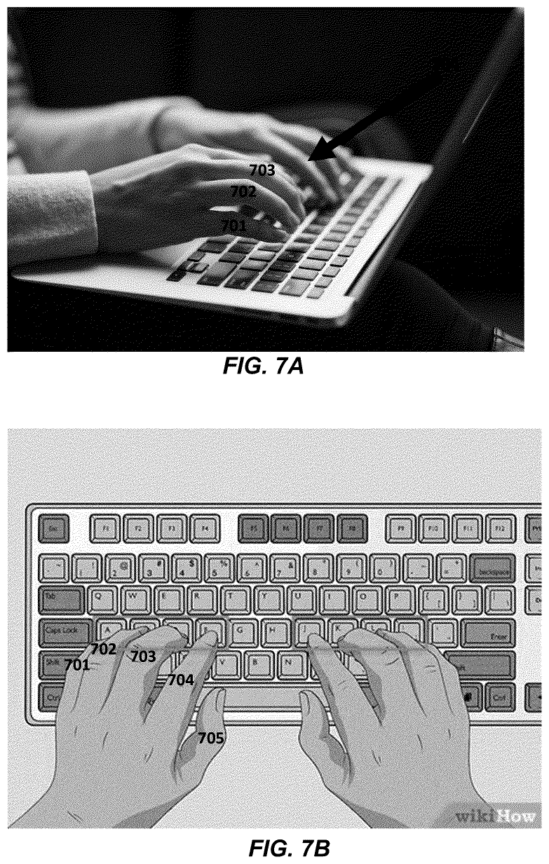

FIG. 7A and 7B demonstrates the proper hand positioning for typing on a computer or key board. The wearable training units described herein can be used to encourage the slightly bend position of the fingers as required for typing on a computer, with the angle of the bend in the wearable training unit adjusted to encourage the fingers to return to the home row keys, with the left hand on positioned at the “ASDF” keys and the right hand positions on the “JKL; ” keys as shown. Exemplary positions for the wearable training units provided herein include position 701, 702, 703, 704, and 705, each corresponding to a joint on a finger (see 701-704 in FIG. 7A and 701-705 in FIG. 7B).

### Example 3: Manufacturing a Wearable Training Unit for Teaching Curled Finger Position

FIG. 8 provides the size and shape specifications for a wearable training unit designed to wear on a middle knuckle to maintain a bent (curled) finger position while playing piano. These specifications were saved to a CAD file and presented to a manufacturer, who used 3D printing and ESTANE® TPU (thermoplastic polyurethane) to produce the wearable training unit shown in FIG. 1 and FIG. 2. The specifications used to produce these exemplary wearable training units are shown in FIG. 3C, FIG. 3D, and FIG. 8.

1. A wearable device comprising a single unit of housing comprising a flexible material with shape resilience, the single unit comprising a first hollow portion connected to a second hollow portion at a bend, wherein the wearable device is configured to wrap around a finger joint of a subject to encourage a bent position of the joint, and wherein the first hollow portion and the second hollow portion are continuously connected, such that the first hollow portion and the second hollow portion do not separate at the bend.

2. The wearable device of claim 1, wherein the wearable device is configured to encourage the bent position of the joint when worn while the subject is engaging in an activity.

3. The wearable device of claim 2, wherein the activity comprises playing an instrument.

4. The wearable device of claim 3, wherein the instrument is a piano, an organ, an accordion, a harpsichord, an electronic keyboard, a melodica, a spinet, a keyboard glockenspiel, a piano, a celesta, a dulcitone, or a synthesizer.

5. The wearable device of claim 2, wherein the activity is typing on a keyboard.

6. The wearable device of claim 1, wherein the housing comprises a cylindrical, tubular, or otherwise hollow shape which is maintained in an elbowed structure.

7. The wearable device of claim 1, wherein the joint comprises the distal interphalangeal joint.

8. The wearable device of claim 1, wherein the joint comprises the proximal interphalangeal joint.

9. The wearable device of claim 1, wherein the bend is at an angle greater than 90°.

10. The wearable device of claim 9, wherein the angle is greater than 120°.

11. The wearable device of claim 9, wherein the angle is from about 100° to about 170°.

12. The wearable device of claim 11, wherein the angle is from about 110° to about 160°.

13. The wearable device of claim 12, wherein the angle is from about 120° to about 150°.

14. The wearable device of claim 13, wherein the angle is from about 130° to about 140°.

15. The wearable device of claim 14, wherein the angle is 135° or about 135°.

16. The wearable device of claim 1, wherein the flexible material comprises a polymer.

17. The wearable device of claim 1, wherein the flexible material comprises silicone, thermoplastic polyurethane, thermoplastic copolyester, thermoplastic elastomer, or polypropylene.

18. The wearable device of claim 17, wherein the flexible material comprises thermoplastic polyurethane.

19. A method of manufacturing the wearable device of claim 1, the method comprising: A) determining (i) a circumference of a finger on the subject and (ii) a desired resting position of the joint in the finger; B) preparing, based at least in part on (i) and (ii), a model of wearable device; C) providing the model to a 3D printer configured to produce the wearable device, thereby manufacturing the wearable device.

20. A method of using the wearable device of claim 1, comprising wearing the wearable device during an activity associated with a proper hand positioning to encourage the proper hand positioning during the activity associated with the proper hand positioning, wherein the activity is playing an instrument.
